(19) United States
(12) Patent Application Publication
(10) Pub. No.: US 2014/0196022 A1
(43) Pub. Date: Jul. 10, 2014

(54) Cloud Based Application Packaging

(71) Applicants: Alexey Skutin, Odintsovo (RU); Dmitry Lazarenko, Moscow (RU); Constantin Alexandrov, Voronezh (RU); Ruslan Synytskyy, Kyiv (UA); Viacheslav Katiukha, Zhitomir (UA)

(72) Inventors: Alexey Skutin, Odintsovo (RU); Dmitry Lazarenko, Moscow (RU); Constantin Alexandrov, Voronezh (RU); Ruslan Synytskyy, Kyiv (UA); Viacheslav Katiukha, Zhitomir (UA)

(21) Appl. No.: 14/150,647

(22) Filed: Jan. 8, 2014

Related U.S. Application Data
(60) Provisional application No. 61/750,249, filed on Jan. 8, 2013.

(51) Int. Cl. G06F 9/445

(52) U.S. Cl. CPC G06F 8/61
USPC 717/176

(57) ABSTRACT

A new system and method for cloud based application packaging is disclosed, comprising a platform-independent manifest file that can deploy an application into any cloud environment.

### CROSS-REFERENCE TO RELATED APPLICATIONS

The present application claims the benefit of U.S. Provisional Patent Application No. 61/750,249, filed Jan. 8, 2013, which is incorporated herein by reference in its entirety.

### BACKGROUND

Cloud computing has been a revolutionary change in information technology, allowing large and small enterprises to transform their computing resource use. The number of cloud computing platforms is continuously increasing, and more and more web applications are developed specifically for the cloud. The concept of cloud computing has influenced the development, deployment, use, and delivery of web applications to end users.

The incredible growth of cloud platforms and applications designed for the cloud requires more and more resources spent on distribution and maintenance of applications in the cloud. Different manufacturers' cloud platforms have different architectures, while cloud applications work with standard programming languages. Due to the difference in architecture between different cloud platforms, the deployment and maintenance process of a cloud application becomes a complex and therefore expensive process. A platform-independent packaged application is therefore needed.

### SUMMARY OF THE INVENTION

One object of the present invention is to provide a system and method for deploying a cloud application into any cloud platform, regardless of architecture or structure.

The method of the present invention comprises creating an application package, said application package comprising a manifest file. The manifest file preferably comprises a cloud environment specification, a deployment section, which contains application modules and resources, a configuration section, which contains any configuration scripts needed by the application, a settings section, and an actions section. The manifest file can be in any platform-independent format, such as XML, JSON, YAML, or any other format known in the art. In an embodiment, the manifest file also comprises a billing and payment section, containing information about billing frequency, billing type, provided services, and provided resources. In another embodiment, the manifest file may also comprise a list of actions that can be performed on the package.

The method of the present invention further comprises using a deployment processor to parse and execute the instructions in the manifest file, creating or modifying a cloud environment, configuring the application database, installing at least one initialization file, at least one application file, and any needed resources into the cloud environment, and configuring the application. Add-on modules may also be loaded and installed, and additional parameters may also be transmitted to the application after installation.

The system of the present invention comprises at least one storage repository for storing application packages, and at least one microprocessor, programmed to receive an application package comprising a manifest file, parse and execute the instructions in the manifest file, create or modify a cloud environment, deploy at least one initialization file and at least one application file into the cloud environment, and configure the application. In an alternate embodiment, instead of deploying an initialization file and application file, the system of the present invention deploys an add-on module that modifies an existing application or the topology of the cloud environment.

### BRIEF DESCRIPTION OF THE DRAWINGS

FIG. 1 shows the life cycle of a packaged application from its creation to its deployment into a cloud platform.

FIG. 2 shows the structure of a packaged application and the description of each section in the package.

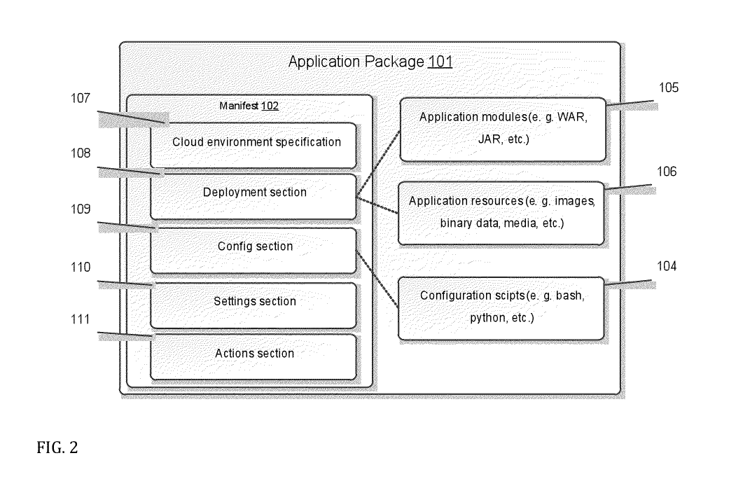

FIG. 3 shows the process of transforming the information in the package into a working cloud application.

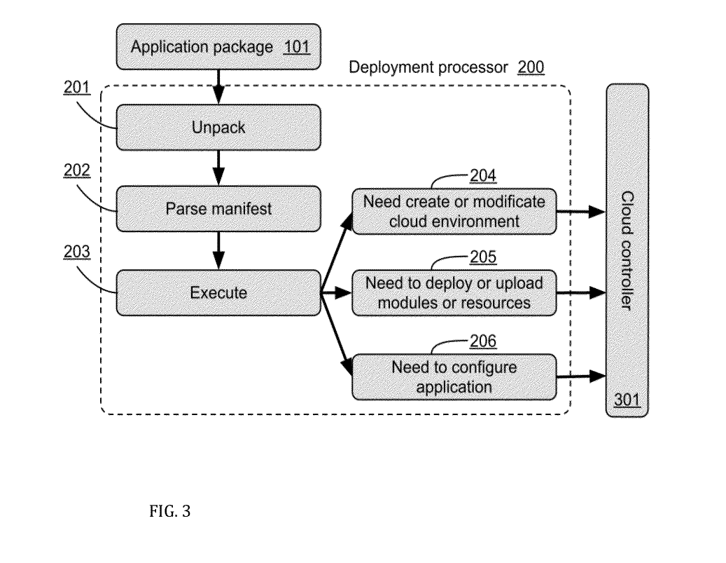

FIG. 4 shows the cloud with a deployed, installed, and operating application.

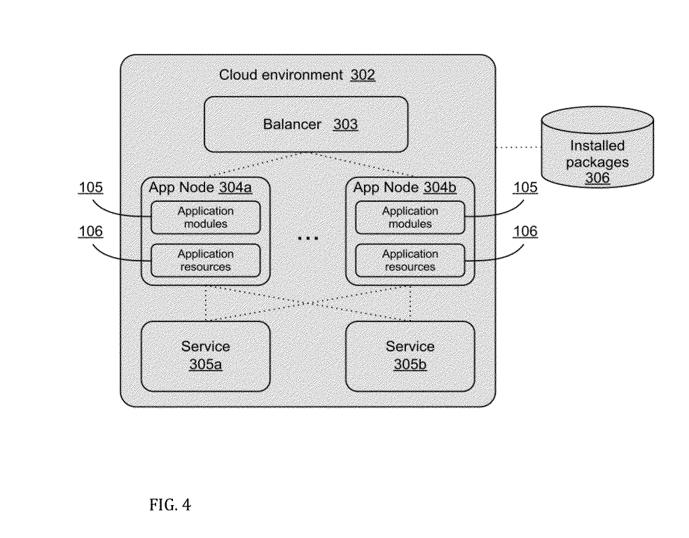

FIG. 5 shows the billing and payment structure.

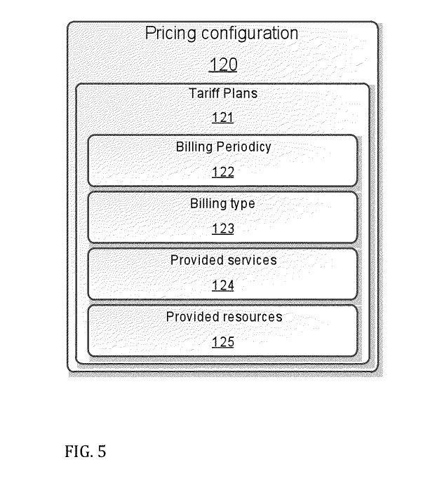

### DETAILED DESCRIPTION OF EXAMPLE EMBODIMENTS OF THE INVENTION

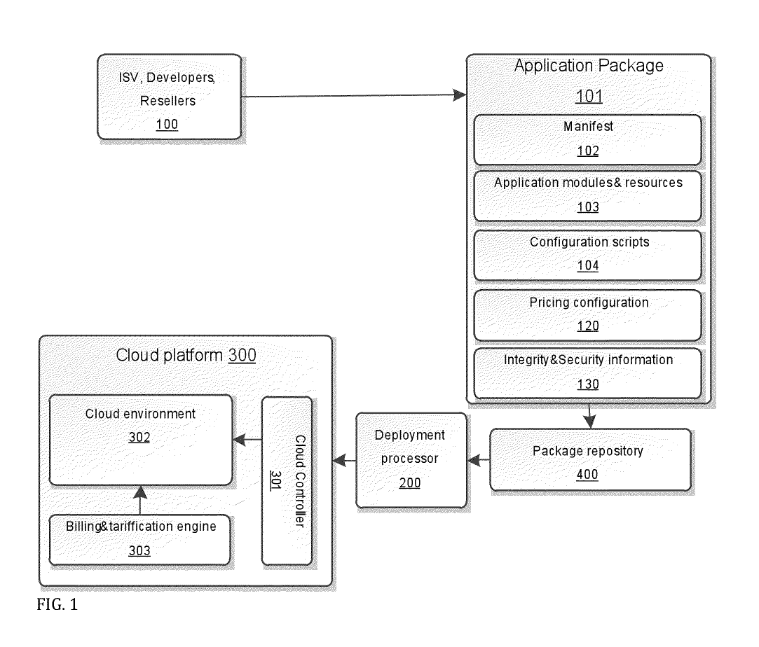

The present invention enables cloud based packaging of applications by developers, hosting services, and resellers 100, as shown in FIG. 1. Any web application can be packaged in this manner: CMS, CRM, blogs, banking apps, and so on, as well as the server parts of games and mobile apps. Additionally, cloud based application packaging may be used with add-on modules that are not independent apps but rather extend the functionality of existing apps.

The present invention may be used not just for applications and add-ons, but also as a means of automatically changing the structure of the cloud-based environment and configuration of the packaged application 302 when certain conditions are met—for example, when a node is added or removed from the cloud environment.

Applications to be packaged must be able to work in virtual environments, whether hardware-based, paravirtualization, or containers. Applications must not require a window-based manager. The purpose of packaging applications is to enable multiple installations and distribution in different cloud-based environments.

The end result of cloud based application packaging is a package 101, which includes a manifest file 102, the application and resources 103, configuration scripts 104, billing and payment information 120, and digital signature and authentication information 130.

Digital signature and authentication information 130 of the package 101 may be used for the creation of a verified repository of packages 400, which can guarantee the authenticity, integrity, and origin of each package.

Package 101 may comprise an archive or just a single manifest file 102. If the package 101 comprises only a manifest file 102, the application and resources 103 and the configuration scripts are stored online and may be accessed via the links indicated in the manifest file 102.

Package 101 may be distributed by any channels known to the art of cloud computing, as long as the format of the package is preserved.

Package 101 may be stored and transferred to the deployment processor 200 from a package repository, whether a centralized or a decentralized one.

Manifest file 102 can be in any platform-independent format, such as XML, JSON, YAML, or any other platform-independent format known in the art. Manifest file 102 is a file that describes and implements the installation process of the cloud application in a format that is supported by the given cloud provider. If the manifest file 102 is in the XML format, digital signature and authentication information 130 is preferably in the XML-DSIG format.

Manifest file 102 preferably contains several sections, to describe the specification of the cloud environment 107, the description and paths to the deployment modules 108, the configuration of the deployed application 109, any additional settings 110 that are set by the user at the start of the package's installation in the cloud environment, and a dynamic list of actions 111 that can be performed on the package in certain conditions.

The list of actions 111 can include actions that an end user can perform manually on the installed package, for example setting a password for a database. The list of actions 111 can also include actions that the cloud controller will have to perform at various stages of the life cycle of the cloud environment:
Vertical scaling up
Vertical scaling down
Horizontal scaling up
Horizontal scaling down
Adding an example database
etc.

The deployment section 105 can comprise links or relative paths to the applications modules in WAR, JAR, or binary formats, storage repositories for source code (such as GIT, SVN, Mercurial, etc.), and so on.

Application resources 106 are also described in the deployment section 105 and comprise links to image files, binary files, audio and video data, and so on.

The process of installing the application can be broken up into the following stages:

1. Receiving the list of all needed installation parameters.

2. Creating the cloud environment of the given topology.

3. Modifying the topology of the cloud environment.

4. Loading and installing add-on modules.

5. Configuring the application database.

6. Deployment of the initialization files of the application.

7. Deployment of the application files, using a version control system.

8. Licensing of the application and any add-ons.

9. Initial configuration of the application.

10. Communicating to the user(s) that the installation is complete.

Configuration scripts 104 are not required; if used, they are included in the configuration rules 109. Configuration scripts 104 may be implemented in different programming languages and include specific configuration logic that cannot be supported on the packaging level. For example, a configuration script may be used to create a user after the application has been installed in a cloud environment, to set access rights, to install an additional plugin, and so on. Configuration scripts 104 are run during installation of the package 101 in the deployment processor 200, and are used either at a particular stage of the installation of the application, or immediately before or after a particular stage of installation.

During installation of the package 101, additional parameters may be given to the application; for example, a licensing key or user data. These additional parameters are described in the settings section 110, and their values are automatically transmitted to the application during installation.

Installation of the package 101 is performed by the deployment processor 200. The deployment processor 200 uses the data from the package 101 and recreates the cloud environment based on the specification described in the manifest file 102.

The deployment processor 200 communicates via the API with the cloud controller 301 of the cloud platform 300. The deployment processor 200 comprises an unpacking module 201, a manifest parser 202, an execution module 203 that executes the rules in the manifest file, and a module that performs key operations listed as 204, 205, and 206 on the cloud platform 300 through the API of the cloud controller 301.

The package 101 is first processed by the unpacking module 201. After unpacking, the data from the manifest file 102 is sent to the manifest parser 202. After parsing of the manifest file 101, the data is sent to the execution module 203. During execution, the execution module 203 sends various commands to the cloud platform 300.

The unpacking module 201 unpacks the files in the package from an archive if the package was given in an archive form, and locally loads all the resources that are given as web links in the manifest. After unpacking of the package 101 by the unpacking module 201, all the resources of the package are accessible in the local storage of the package repository 400 for any subsequent operations.

The unpacking module 201 unpacks the files of the package 101 only once for every time that the package is imported into the deployment processor. By the time the deployment processor 200 deploys the package, all the resources are already extracted from the package or loaded from the web and are in the local storage of the package repository 400.

The cloud controller 301 is part of the cloud platform 300 and enables interactions with the platform via the API. The deployment processor 200 can use the cloud controller 301 to create a new cloud environment or several cloud environments 302, linked according to the specification 107, deploys needed modules 108, and configures the cloud application.

Cloud environment 302 comprises one or several stacks (web servers, databases, application servers) with any needed code that the cloud application requires. The cloud environment 302 is created by the cloud controller 301. The cloud controller 301 is responsible for satisfying any dependencies that are required to create any cloud environment.

The configuration of the cloud environment 302 is preferably described in a declarative manner—for example, as “Environment Settings” in the application.

Each component of the cloud environment can be described in the manifest as follows:
a. Identifier of the standard application stack;
b. Identifier of the language configuration of the environment;
c. List of additional modules to be installed from external sources;
d. List of additional package dependencies
e. List of add-on packages that must be installed in the given component of the environment

Packages may be hierarchically organized into a structure of packages that depend on each other. The installation of a package that is higher up on the hierarchy will then lead to the automatic installation of all the other packages that are lower down on the hierarchy.

The cloud controller 301 places the application modules 105 into the application servers 304; creates needed services 305 that are required for the application to work; and creates a load balancer 303 if it is required by the application. Application resources 106 may be located on the application servers 304, or at a separate storage location in the cloud environment 302.

Services 305 may be databases (such as MySQL, PostgreSQL, etc.), cache servers (such as Memcached), project management tools (such as Maven), etc. Required services 305 are listed in the manifest 102.

The package may add services 305 and resources 106 to an existing cloud environment. Packages that change an existing cloud environment are called add-ons.

Add-ons may be used to expand the functionality of an application by third-party services, changes in cloud configuration, or new versions of an application in the cloud environment.

The package 101 may include billing and payment meta-information 120 that can bill users of the cloud platform for using the application. The billing and payment meta-information 120 may include a list of payment plans 121, each of which may correspond to a particular configuration of the cloud environment 302, and a list of services 124 and resources 125 of the application.

The cloud platform 300 may include a billing/payment processor 303, which, if the package 101 contains billing/payment meta-information 120, can use it to bill users for the services and resources provided by the application.

The process of packaging the application can be performed as follows:

1. Manually creating a cloud environment of the needed topology and configuration.

2. Manually loading and installing any additional modules required for the application to work.

3. Manually configuring the application database.

4. The application is installed manually into the created cloud environment, and configured to use the appropriate database.

5. Initial configuration of the application.

6. The manifest file is created, comprising configuration data of the default cloud environment.

7. Dumping of the configuration files of the application that is installed in the default cloud environment.

8. Dumping of the database of the application installed in the default cloud environment.

9. Template creation based on the dumped configuration files of the application and the database.

10. Templates of the configuration files and database are added to the package as resources.

11. Configuration scripts are added to the manifest file.

12. A licensing section is added to the package.

13. Billing and payment information is added to the package.

14. The package is published in a package repository 400.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A method of deploying a cloud application, comprising:
receiving an application package, said package comprising a manifest file;
parsing the manifest file;
executing the instructions in the manifest file;
performing one of the following group of actions: creating a cloud environment or modifying an existing cloud environment;
configuring an application database;
making a change to the cloud environment based on the instructions in the manifest file.

2. The method of claim 1, where making a change to the cloud environment comprises:
deploying at least one application initialization file into the cloud environment;
deploying at least one application file into the cloud environment;
configuring the application.

3. The method of claim 1, further comprising:
reading the manifest file to determine whether any other packages are dependent on the application package;
retrieving and unpacking any other packages that are dependent on the application package.

4. The method of claim 1, where making a change to the cloud environment comprises:
deploying an add-on into the cloud environment to change an existing application.

5. The method of claim 1, further comprising:
loading and installing add-on modules into the cloud environment.

6. The method of claim 1, further comprising:
transmitting additional parameters to the application after it is installed.

7. The method of claim 1, where the manifest file comprises:
a cloud environment specification;
a deployment section, comprising application files and application resources;
a configuration section, comprising configuration scripts;
a settings section;
an actions section.

8. The method of claim 7, where the deployment section comprises links to one or more of the following: application files, storage repositories for source code, application resources.

9. The method of claim 7, where the configuration section comprises configuration scripts.

10. The method of claim 7, where the manifest file further comprises:
a billing and payment section.

11. The method of claim 10, where the billing and payment section comprises information about billing frequency, billing type, provided services, and provided resources.

12. The method of claim 1, where the manifest file is one of the following group: an XML file, a JSON file, a YAML file.

13. The method of claim 1, where the manifest file further comprises a list of actions that can be performed on the package.

14. The method of claim 1, where the manifest file further comprises information about package dependencies.

15. A method of creating an application package, comprising:
creating a cloud environment of a desired topology and configuration;
configuring an application database;
installing and configuring an application into the cloud environment;
creating a manifest file, said manifest file comprising configuration data for the cloud environment;
creating templates based on the configuration of the database and the application;
adding the templates to the package as resources;
publishing the package in a package repository.

16. The method of claim 15, further comprising:
adding configuration scripts to the manifest file.

17. The method of claim 15, further comprising:
adding billing and payment information to the manifest file.

18. A cloud computing system, comprising:
at least one storage repository; and
at least one microprocessor, programmed to:
create a package comprising a manifest file, said manifest file comprising a cloud environment specification, a deployment section, a configuration section, and a settings section, said package also comprising at least one application module, application resources, and configuration scripts;
upload the package into a storage repository;
download the package from the storage repository;
unpack the application package;
parse the manifest file;
execute the instructions in the manifest file;
create or modify a cloud environment;
deploy the application into the cloud environment;
configure the application.

19. The system of claim 18, where the cloud environment comprises at least one application node, said application node comprising application modules and application resources, and a load balancer.
